(19) United States
(12) Patent Application Publication
(10) Pub. No.: US 2018/0240050 A9
(43) Pub. Date: Aug. 23, 2018

(54) Method of Order Fulfillment

(71) Applicant: Amit Dahiya, San Diego, CA (US)

(72) Inventor: Amit Dahiya, San Diego, CA (US)

(21) Appl. No.: 15/011,481

(22) Filed: Jan. 30, 2016

Related U.S. Application Data
(60) Provisional application No. 62/125,826, filed on Feb. 2, 2015.

(51) Int. Cl. G06Q 10/06; H04W 4/02; H04W 8/00

(52) U.S. Cl. CPC G06Q 10/0633; H04W 8/005; H04W 4/023

(57) ABSTRACT

Business delivers product/s or service/s to customer using live location provided by customer's wireless device's live location which is shared by customer with the business. At the same time the business is sharing the delivery person's wireless device's live location with the customer. This enables self-discovery of the delivery person and the customer hence delivering the product/service to the customer.

### CROSS-REFERENCE TO RELATED APPLICATIONS

This application claims the benefit of provisional patent application Ser. No. 62/125,826 filed Feb. 2, 2015 by the present inventor.

### BACKGROUND-PRIOR ART

The following is the tabulation of some prior art that presently appears relevant:

| Patent Number | Patentee |
|---|---|
| US20120072311 A1 | Mohammad Khan |

Many businesses lose revenue because they don't have drive-through service to accommodate customers' needs and do not have the space or facilities to provide it. Also, there are times when a customer enters the business and there is a long line to wait for service, which may cause some customers to decide not to purchase from the business at all. In other instances, the customer may not want to enter the store due to disability or pet restrictions or do not want to remove children.

Patent US20120072311 A1 (Khan, 2012) proposes the use of wireless devices associated with a customer in a designated area for the merchant to know the presence of the customer and to process an order. The patent requires the customer to be in a designated area and that the customer's wireless device be able to interface with the business touch point and only then the business will know to start processing the order and deliver the order to the designated touch point location. This produces a number of dis-advantages:
a) This requires the creation of infrastructure like:
   a. Designated parking spots
   b. Touch points to interface with wireless devices
      i. Touch points are very finicky; many customers may not know to turn on their NFC
   c. Business to have equipment installed to detect customer location
   d. If a customer is inside the business, the customer has to find designated tables
b) The customer cannot see live if the order is being delivered and in many cases may frustrate the customer to go inside the store to inquire
c) Businesses in high density areas, small parking lots will have a hard time to get designated parking spaces for their own business only and in many instances will lead to underutilization of parking spaces E.g. Dedicated parking for Dry cleaners will be more in use in early evening hours and less in use during other hours.

### SUMMARY

Business delivers product/s or service/s to customer using live location provided by customer's wireless device's live location which is shared by customer with the business. At the same time the business is sharing the delivery person's wireless device's live location with the customer. This enables self-discovery of the delivery person and the customer without the need for the business to have drive-thru or other infrastructure like dedicated parking spots etc.

### DRAWING

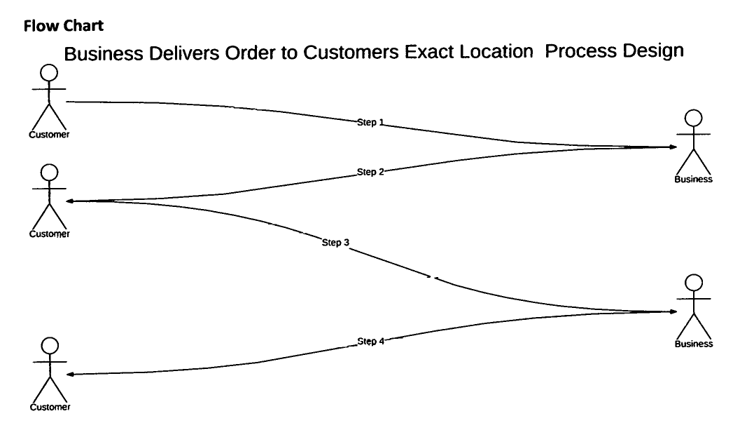

After a customer has placed an order with a business, (FIG. 1, Step 1 in attached drawing), the business using a wireless location enabled mobile device sends a uniquely identifiable piece of data through an electronic message to the customer's location enabled mobile device (FIG. 1, Step 2). When the customer is in the vicinity of the business and interacts with the piece of data (FIG. 1, Step 3) it will enable the customer's mobile device to share customer's mobile device location with the business. The customer can be in the vicinity of the business (such as in the parking lot), or the order can be walked to the customer inside the business so that the customer does not have to stand in line. As soon as the business can see the location of the customer on the business' mobile device, the business will delivery person will deliver the order to the customer (FIG. 1, Step 4) while the delivery person is also sharing its mobile device location with the customer's mobile device leading to self-discovery.

### ALTERNATIVE EMBODIMENTS

Instead of using location tracking on a costumer's electronic device, two possible alternatives could be:
a) Using face recognition software to recognize when the customer is in the vicinity of business, enabling delivery; or
b) The business could identify the customer's car and associate it with the order.

### Alternative Uses

My business process can be used in situations in which part of the business process is done using phone or Internet communication but the other step in the business process requires the customer to visit the business. If the business can know exactly when the customer is in the vicinity of the business the business process can be completed with ease. Examples include Notary Public, pharmacy delivery, food orders, etc.

My business process can also be used to create a system of re-ordering a customer's regular order (of a product or service). For example, if a customer orders the same coffee drink on a daily basis from the same business, the business would be able to prepare and have the drink ready as soon as the customer walked in using the notification system.

### Advantages

My business process has the following advantages:
a) Business which previously would lose sales as they did not have a drive thru can now deliver products or services when the customer is in the vicinity
b) Disabled customers who have hard time finding parking can get service using my business process
c) Customers who cannot enter business's because they have kids in the car and don't want to go through the trouble to take the kids out of the car
d) Customers who have pets with them but are not allowed to bring non service animals inside businesses
e) Enabling exchange of goods and services when the business does not have a brick and mortar store but has to stay mobile E.g. Ice cream vendor in park, taco stand etc.

### Ramifications

a) Business will not lose sale to online vendors as customers are more willing to drive to pick up already packed goods
b) Business will not lose sale even when the customer is unable to find parking
c) Business will not lose sale when there is no drive-thru
d) Food delivery services will save on delivery drivers as customers will want to pick up orders for faster service
e) Business will not lose sales when customer is discouraged on seeing a long line at the business as the customer can use my business process to deliver as soon as customer walks in

I claim:

1. A process to deliver product or service by a business to a customer using customer's wireless device's live location while at the same time the business is sharing the delivery person's wireless device's live location with the customer leading to self-discovery of the delivery person and the customer thereby reducing the business's need for a drive-thru or dedicated parking.
